(19) United States
(12) Patent Application Publication
(10) Pub. No.: US 2005/0268706 A1
(43) Pub. Date: Dec. 8, 2005

(54) System for monitoring the state of a tyre

(76) Inventor: Norbert Polzin, Zaberfeld (DE)

Correspondence Address: KENYON & KENYON, ONE BROADWAY, NEW YORK, NY, 10004, US

(21) Appl. No.: 10/507,668

(22) PCT Filed: Mar. 13, 2003
(86) PCT No.: PCT/DE03/00797

§ 371 Date: Jul. 28, 2005

(30) Foreign Application Priority Data
Mar. 16, 2002 (DE) 102 11 697.0
Jan. 30, 2003 (DE) 103 03 492.7

(51) Int. Cl. G01M 17/02

(52) U.S. Cl. 73/146

(57) ABSTRACT

A method and device for monitoring the tire state at the driven wheels of a motor vehicle, in which angular motions of the driven wheels are measured and variables, which are a function of measured angular motions, are generated. The generated variables are combined with each other. The monitoring takes place as a function of the operation result. The drive torque acting on the driven wheels is taken into consideration in the monitoring. For different kinds of tires, the rolling circumference changes as a function of the drive torque in such a sharply varying manner, that a change in the rolling circumference caused by a loss of pressure may be offset and is not detected. If the effect of the drive torque is now considered in detecting a loss of tire pressure, then, even in such cases, the loss of pressure may be detected reliably and without detection errors.

### FIELD OF THE INVENTION

The present invention is based on a system for monitoring a tire state.

### BACKGROUND INFORMATION

It is believed that there are different variations of systems for detecting a tire state. In addition to systems which directly sense the tire pressure, it is also understood that the changes in the tire diameter caused by loss of air or increased wear can be sensed in such a manner, that the rotational speeds of the wheels can be evaluated (or sensed, by evaluating the rotational speeds of the wheels).

Thus, German patent documents nos. 36 30 116 and 32 36 520 discuss or refer to a device for displaying the state of tires of a vehicle, where the differences in the rotational speeds of individual wheels are ascertained in particular operating states (brakeless, constant-speed, straight-ahead driving). In particular, it is proposed that these rotational speeds be normalized with respect to the specific vehicle speed.

European patent document no. 0 291 217 discusses or refers to differences in the rotational speeds of individual wheels can be used for detecting a tire state.

German patent document no. 41 13 278 discusses or refers to a tire-tolerance adjustment (compensation), where, in order to compensate for the wheel speeds, ratios of the rotational speeds of wheels on each side of the vehicle are calculated, and correction values for compensation are derived from them.

### SUMMARY OF THE INVENTION

The object of the exemplary embodiment and/or exemplary method of the present invention is to optimize the detection of a tire state.

The exemplary embodiment and/or exemplary method of the present invention starts out from a method and a device for monitoring the tire state at the driven wheels of a motor vehicle. For the monitoring, the angular motions of the driven wheels are measured and variables, which are a function of the measured angular motions, are generated. In addition, the generated variables are combined with each other. The monitoring then takes place as a function of the operation result. With the exemplary embodiment and/or exemplary method of the present invention, the drive torque acting on the driven wheels is also taken into account in the monitoring.

The background of the exemplary embodiment and/or exemplary method of the present invention is that, in the case of different kinds of tires, the rolling circumference changes as a function of the drive torque in such a sharply varying manner, that a change in the rolling circumference caused by a loss of pressure may be offset and is therefore not detected. For the same reason, incorrect detection of pressure losses may occur. If the effect of the drive torque is now considered in the detection of a loss of tire pressure in accordance with the exemplary embodiment and/or exemplary method of the present invention, then, even in such cases, the loss of pressure may be detected reliably and without detection errors.

An exemplary embodiment of the present invention provides for a signal representing the tire state to be generated as a function of the result of the operation, and as a function of the drive torque acting on the driven wheels. In this embodiment, a display arrangement is provided which indicate the tire state on the basis of the signal of the evaluating arrangement.

Another exemplary embodiment of the present invention provides for at least two operation results to be determined at at least two different drive torques, and for the change in the operation results with respect to these drive torques to be taken into account in the monitoring.

As an alternative to this, or in addition to this, it may be provided that at least two operation results be determined at at least two different drive torques, and that the change in the operation results with respect to these drive torques be taken into account when generating the indicator signal.

In the case of the last-mentioned, specific embodiments, the change in the operation results with respect to the drive torques is compared to at least one threshold value. The monitoring then takes place as a function of the comparison result, and/or the signal is generated as a function of the comparison result.

It may also be provided that the monitoring of the exemplary embodiment and/or exemplary method of the present invention not be used during all operating states. Thus, for example, the drive torque acting on the driven wheels may only be taken into account for the monitoring in the presence of low drive torques, in particular in the presence of drive torques below a threshold value. In this connection, it is particularly provided that
the drive torque acting on the driven wheels is taken into account for the monitoring in the presence of low drive torques, in particular in the presence of drive torques below a threshold value; and
that in the presence of higher drive torques, in particular in the presence of drive torques greater than a threshold value, the monitoring takes place independently of the drive torque acting on the driven wheels.

The monitoring may be advantageously implemented in an all-wheel-drive vehicle. In this case, in addition to the wheel speeds of the driven wheels, the wheel speeds of the non-driven wheels may also be taken into consideration in the monitoring. In this connection, an operation (or operating mode) of the all-wheel-drive vehicle, where a further wheel-drive assembly is only switched on as required, is, for example, conceivable. Furthermore, it is provided that the detected wheel speeds be combined to form different operation results.

Thus, redundant monitoring may be carried out or performed, for example, when an operation result provides for an axial linkage of the wheel speeds and another operation result provides for a diagonal linkage of the wheel speeds. In addition, the activation of the differential lock present in the vehicle may be taken into account in the monitoring. Thus, it is conceivable that the linkage of the wheel speeds by an axial differential lock, i.e. axial locking, and/or by an interaxle differential lock between the axles results in a positive coupling of the wheel speeds and has an effect on the monitoring. The determination of a loss in pressure may be improved by taking the differential lock into consideration for the monitoring.

### BRIEF DESCRIPTION OF THE DRAWINGS

FIG. 1 shows a block diagram of the system according to the present invention.

FIG. 2 shows the dependence of a differential wheel speed on the drive torque.

FIG. 3 also shows the dependence of a differential wheel speed on the drive torque.

FIG. 4 also shows the dependence of a differential wheel speed on the drive torque.

FIG. 5 also shows the dependence of a differential wheel speed on the drive torque.

FIG. 6 shows the exemplary embodiment with the aid of a flow chart of the exemplary method.

### DETAILED DESCRIPTION

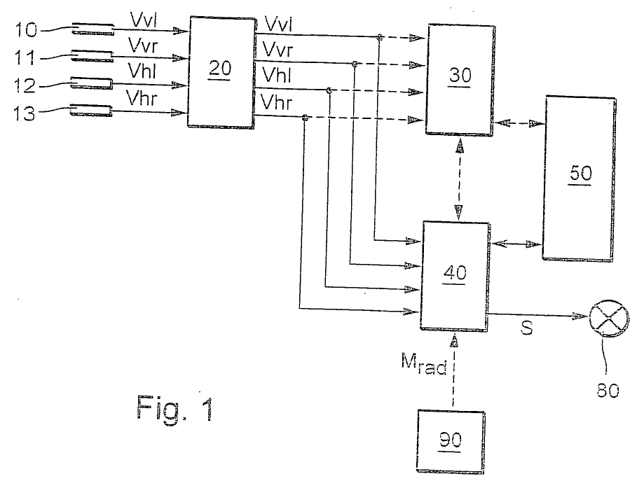

Using reference numerals 10, 11, 12, and 13, FIG. 1 shows rpm sensors which detect rotational speeds Vij (Vvl, Vvr, Vhl, Vhr) of four wheels of a motor vehicle (not shown). In this context, subscript i means the assignment to the front (i=v) or rear (i=h) vehicle axle, and subscript j means the assignment to the right (j=r) or left (j=l) side of the vehicle.

Wheel speeds Vij are supplied to ABS and/or ASR and/or ESP module 20, module 20 taking the form of a known anti-lock braking system and/or traction control system and/or driving stability system (electronic stability program), by which variables (e.g. tire slip and/or wheel deceleration) are calculated from the wheel speeds in a known manner, in order to bring the lock-up tendency and/or the slipping tendency of the wheels and/or e.g. a yaw behavior of the vehicle up to a desired standard.

In addition, wheel-speed signals Vij may be supplied to units 30 for compensating for tire tolerances. Here, correction values for correcting the wheel-speed signals are ascertained in a known manner. This is done, because different tire diameters can feign (or misrepresent) different slip magnitudes (or variables) and may consequently deteriorate the ABS and/or TCS and/or ESP control. To this end, the wheel speeds are compared to each other in a known manner in certain operating states (no slip, e.g. brakeless, constant-speed, straight-ahead driving), and the correction values are derived from the deviations. The correction values may then be stored in a memory 50.

Unit 40, which is used for detecting the tire state and also receives wheel speeds Vij, is essential or at least important to the exemplary embodiment and/or exemplary method of the present invention. If a tire defect, e.g. a loss of tire pressure, is detected, then an indicating device 80 is activated by unit 40, using signal S. In the simplest case, this indicating device 80 may be a warning light, which simply indicates whether or not a tire defect was detected. In this case, signal S must only assume two values. In addition, indicating device 80 may be designed to indicate the tire having the defect.

It is essential or at least important to the exemplary embodiment and/or exemplary method of the present invention that wheel torque Mwheel currently acting on the driven wheels is supplied to unit 40 by engine control unit 90. This wheel torque may be calculated, for example, using the output engine torque available in modern engine control units, in view of the gear (transmission) ratio and, in some instances, a converter and other units situated in the drive train between the engine and the wheels.

To clarify the exemplary embodiment and/or exemplary method of the present invention, conventional monitoring systems will initially be discussed in detail in the following.

In a vehicle, known tire-pressure control systems are normally not connected or networked with other systems, which control or regulate driving functions. In such systems mentioned at the outset, only the wheel speed sensors are used. A loss of tire pressure is detected, when the wheel having a loss of pressure shows a divergent wheel speed over a long period of time. In such vehicles having tire-pressure monitoring, a loss of pressure is indicated to the driver. The more rapidly and more reliably a loss of pressure is indicated, the less likely critical driving conditions or thermal damage to the tire occur.

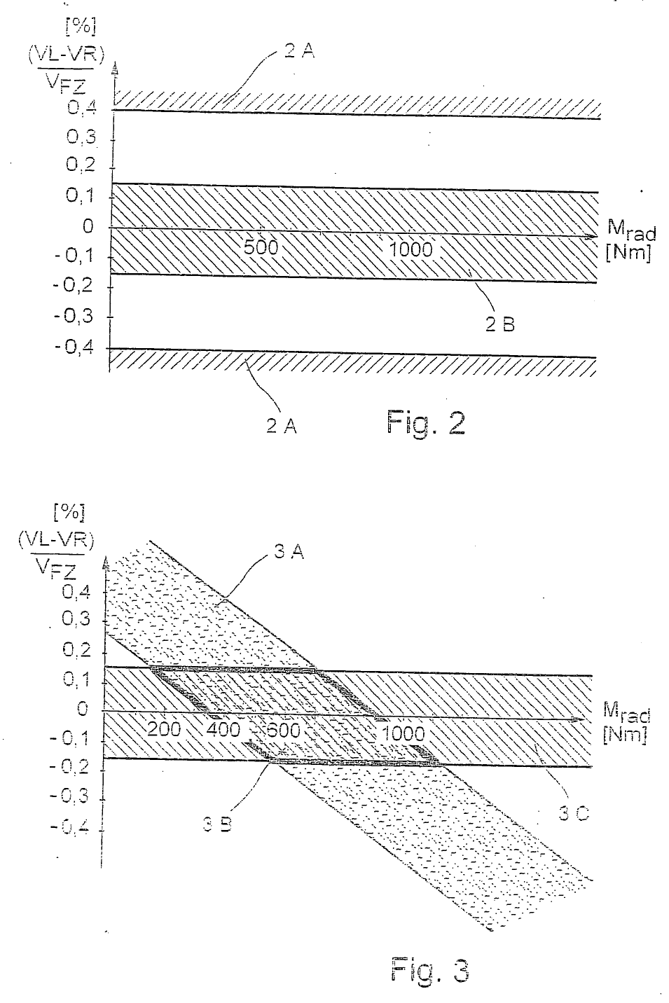

In the evaluation algorithm, differences in the wheel speeds are normally integrated, the differences mostly being calculated axially (with respect to the axles). As soon as one of the differences exceeds a specifiable or parameterizable threshold value, a loss of pressure is detected. This can be seen in FIG. 2.

In FIGS. 2, 3, 4, and 5, the difference
ΔVᵥₗ₋ᵥᵣ=(Vvl−Vvr)/V_{Fz}
of the wheel speeds of the driven wheels, based on longitudinal vehicle speed V_{Fz}, is plotted as a function of wheel torque Mwheel acting on the driven wheels. This exemplary embodiment relates to powered front wheels.

In the following analyses, Vₗ shall be greater than Vᵣ, i.e. there is a loss of pressure in the left front tire. If there is a loss of pressure in the right front tire, then conditions result which are a mirror image of FIGS. 2, 3, 4, and 5.

In the example shown in FIG. 2, the tires on the powered axle of the vehicle are of the same kind. This means that the deformation of the tires, which is a function of the wheel torque, also occurs in an identical manner. Therefore, one obtains the dependence shown in FIG. 2. The values corresponding to the nominal tire pressure are in region 2B. The values indicating a loss of pressure are in regions 2A.

However, in the case of different kinds of tires, the rolling circumference changes so sharply as a function of the drive torque, that a change in the rolling circumference caused by a loss of pressure is offset. If the effect of the drive torque can be considered in the detection of a loss of tire pressure, then, even in such cases, the loss of pressure may be detected reliably and without detection errors.

This dependence on the drive torque can be seen in FIG. 3. In this case, the range whose values indicate a loss of tire pressure is denoted by 3A, while the values in range 3C represent the nominal pressure range.

In the case of non-driven wheels, the rolling behavior at nominal pressure is determined and stored in an EEPROM memory (electronic erasable programmable read only memory) as a desired state (ranges 2B, 3C, 4B, and 5D in FIGS. 2, 3, 4, and 5).

The pressure-loss detection thresholds (for ranges 2A, 5C in FIGS. 2 and 5) are set above the desired state so as to have a safety margin. When a large difference in the wheel speeds occurs in the detection phase, which is made apparent by value ΔVᵥₗ₋ᵥᵣ being exceeded or undershot, then a loss of pressure is detected (comparison of setpoint and actual values). In this context, only driving states without braking control actions or driving control actions, i.e. without considerable wheel accelerations, etc., are considered (FIG. 2).

The “bands” in FIGS. 2, 3, 4, and 5 represent an envelope of measured values.

When the driven wheels have a rolling-circumference characteristic comparable to the non-driven wheels, the previous evaluation algorithm shown with the aid of FIG. 2 may also be reliably used for the powered axle. In the case of a rolling-circumference characteristic as can be seen in FIGS. 3, 4, and 5, the previous algorithm, which operates with a fixed detection threshold, cannot be used for detection.

In FIGS. 3, 4, and 5, one can see that in the case of different kinds of tires, the values of speed differences ΔVᵥₗ₋ᵥᵣ, which indicate a loss of pressure (ranges 3A, 4A, 5A in FIGS. 3, 4, and 5), clearly differ from those of range 2A (FIG. 2, tires of the same kind). In particular, the rolling circumference is not a function of the air pressure in range 3B. This means that in the case of drive torques Mwheel in this range 3B, a loss of pressure cannot be detected in the above-described, conventional manner.

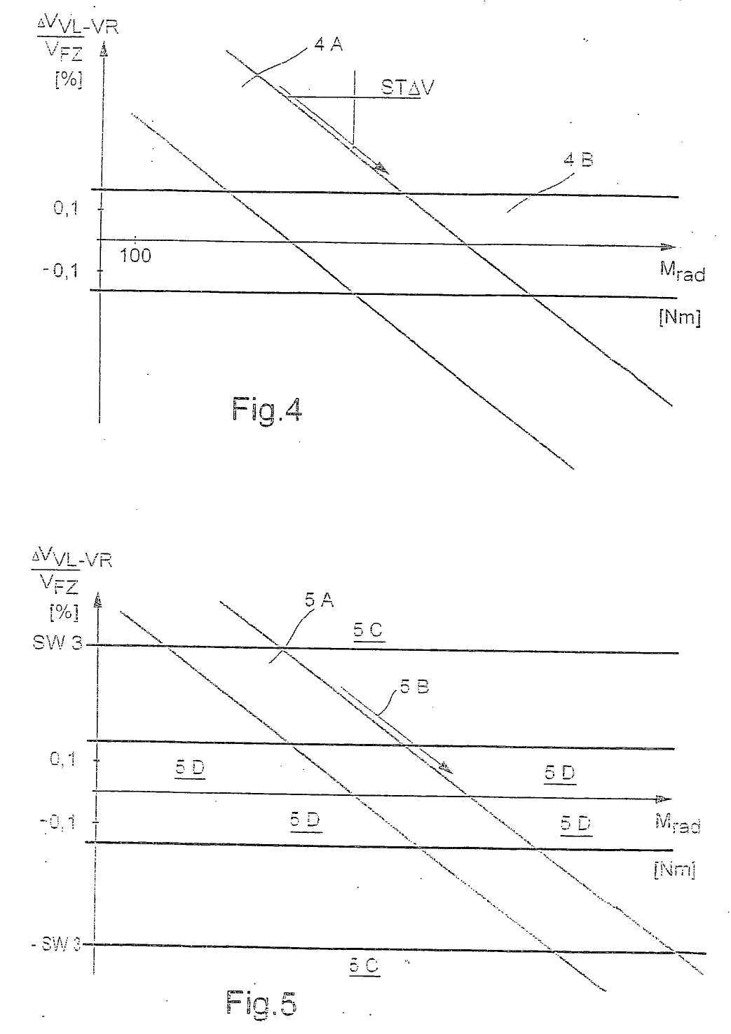

In the case of the detection for driven wheels according to the exemplary embodiment and/or exemplary method of the present invention, the gradient of the rolling circumferences or gradient STΔV of difference ΔVᵥₗ₋ᵥᵣ with respect to the wheel torque is now evaluated. This can be seen in FIG. 4.

As soon as this gradient STΔV exceeds a limiting value (limiting value=gradient_permissable), then a loss of pressure at a driven wheel is detected. As is the case with the previous detection algorithm (FIG. 2), the measured values yielding the scatter range of the rolling circumferences are also cyclically measured and statistically evaluated.

As an alternative, the previous detection (FIG. 2, fixed threshold detection values) may be combined with the detection of the exemplary embodiment and/or exemplary method of the present invention (FIG. 4, detection with the aid of gradient evaluation), as shown in FIG. 5.

In the range of lower wheel torques, the threshold detection value is quickly exceeded in the case of a loss of pressure. In this case, the previous detection is effective (range 5C). In the range of larger wheel torques, a loss of pressure may then be detected from gradient calculation 5B (detection via the described, new method). Therefore, using the additional drive-torque information, a loss of pressure may also be reliably detected for powered wheels.

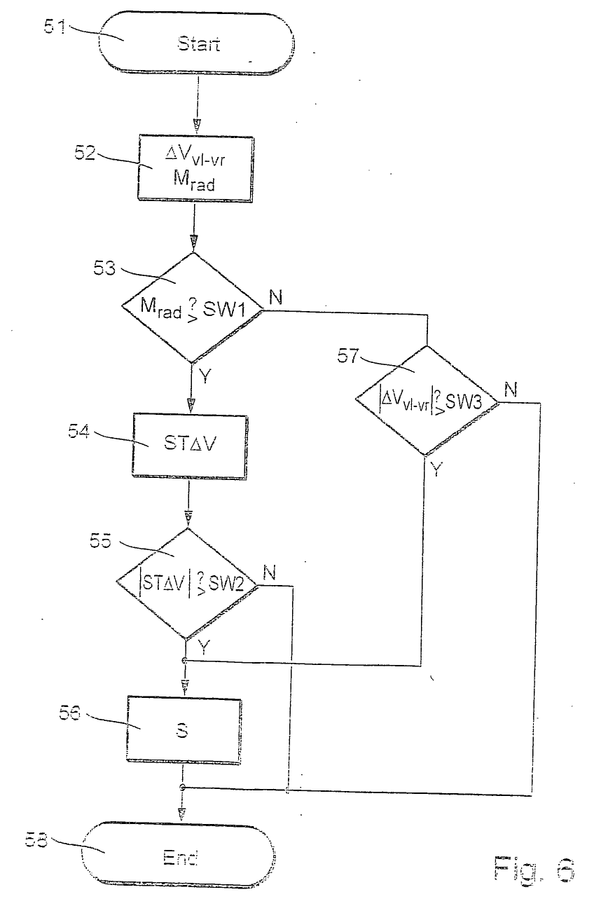

FIG. 6 shows, by way of example, the functional sequence of the specific embodiment according to FIG. 5.

After starting step 51, difference ΔVᵥₗ₋ᵥᵣ is calculated in step 52 from wheel speeds Vvl, Vvr of the driven wheels, according to the above-mentioned formula. In addition, current wheel torque Mwheel is input. In step 53, wheel torque Mwheel is compared to a first threshold value SW1.

If only small wheel torques (less than or equal to SW1) are present, then the conventional detection is carried out for the above-mentioned reasons, using a comparison with a fixed threshold value SW3. If the magnitude of difference ΔVᵥₗ₋ᵥᵣ exceeds value SW3 (range 5C in FIG. 5), then a move is made to step 56, in which the signal S indicating a loss of tire pressure is generated. If the magnitude of difference ΔVᵥₗ₋ᵥᵣ does not exceed value SW3, then no detectable loss of air pressure is present, and the method goes directly to final step 58.

If higher wheel torques (greater than SW1) are present, then gradient STΔV is calculated in step 54. Gradient STΔV represents the change in ΔVᵥₗ₋ᵥᵣ with respect to the wheel torque. In the simplest case, two differential values ≢Vᵥₗ₋ᵥᵣ, which were measured at different wheel torques, are subtracted from each other for this purpose and divided by the difference of the respective wheel torques. In this manner, one obtains the gradient of straight line 5B shown in FIG. 5.

In step 55, the magnitude of gradient STΔV is compared to a threshold value SW2.

If the magnitude of gradient STΔV exceeds value SW2, then a move is made to step 56, in which the signal S indicating a loss of tire pressure is generated. If the magnitude of difference STΔV does not exceed value SW2, then there is no loss of air pressure, and the method goes directly to ending step 58.

After final step 58, the sequence shown in FIG. 6 is run through again.

In a further exemplary embodiment, two different operation results of tire-state variables are ascertained from acquired wheel-speed signals vij according to
Δv_{A}:={(v_{VL}+v_{VR})−(v_{HL}+v_{HR})}/v_{car}.
Δv_{D}:={(v_{VL}+v_{HR})−(v_{VR}+v_{HL})}/v_{car},
the tire-state variables being determined on both an axial (Δv_{A}) and diagonal (Δv_{D}) basis of wheel-speed variables v_{VR}, v_{VL}, v_{VR}, and v_{VL}, normalized with respect to vehicle speed v_{car}. These two tire-state variables are initially calibrated at nominal pressure and are used as reference setpoint values in the subsequent monitoring. The actual state (current wheel-speed difference) is then compared to the desired state. As soon as the setpoint and actual values differ by a parameterizable amount, a loss of pressure is detected and optionally indicated to the driver in an acoustic and/or optical manner. In the case of differentiated (complex) monitoring of the tire states, the drive-torque distribution to the wheels may also influence the monitoring as a further variable.

Moreover, if it is possible to couple the wheels to each other both axially and longitudinally with the aid of a differential lock, as is the case, for example, with all-wheel-drive vehicles, then this information may be used to ascertain the drive-torque distribution. Using this drive-torque distribution, theoretical values of the individual wheel speeds and, therefore, tire-state variables Δv_{A,theor} and Δv_{D,theor} may be obtained. In a further step, tire-state variables Δv_{A} and Δv_{D}, which are based on the real wheel speeds, may then be compared to theoretical values Δv_{A,theor} and Δv_{D,theor}. As soon as the magnitude of the difference between the two different data records exceeds a parameterizable threshold value, then a loss of pressure in a tire is therefore detected.

In this context, all comparison calculations of the speeds are only performed in driving situations, which do not cause the results to be distorted, i.e. only in the case of straight-ahead driving, without significant acceleration/deceleration, without control actions such as ABS, TCS, ESP, . . . . Using the coupling of Δv_{A} and Δv_{D} combined with drive-torque information, a loss of pressure may also be reliably detected in the case of powered wheels that are locked up.

1-12. (canceled)

13. A device for monitoring a tire state at driven wheels of a motor vehicle, comprising:
a detecting and generating arrangement to detect and measure angular motions of the driven wheels and to generate variables that are functions of the measured angular motions; and
an evaluating arrangement, by which the generated variables are combined with each other, and by which the monitoring is performed as a function of an operation result, wherein the evaluating arrangement provides that drive torque acting on the driven wheels is considered in the monitoring.

14. The device of claim 13, wherein the evaluating arrangement provides that a signal representing the tire state is generated as a function of the operation result, and as a function of the drive torque acting on the driven wheels, further comprising:
a display arrangement to indicate the tire state based on the signal of the evaluating arrangement.

15. The device of claim 13, wherein at least two operation results are determined at at least two different drive torques, and a change in the operation results with respect to the drive torques is considered in at least one of the monitoring and the generating of the signal.

16. The device of claim 15, wherein the change in the operation results with respect to the drive torques is compared to at least one threshold value, and at least one of the following is satisfied: the monitoring is performed as a function of the operation result; and the signal is generated as a function of the operation result.

17. The device of claim 13, wherein the drive torque acting on the driven wheels is only considered in the monitoring in the presence of low drive torques below a threshold value.

18. The device of claim 13, wherein the drive torque acting on the driven wheels is considered in the monitoring in the presence of low drive torques less than or equal to a threshold value, and in the presence of higher drive torques greater than a threshold value, the monitoring is performed independently of the drive torque acting on the driven wheels.

19. The method of claim 13, wherein the monitoring is provided on an all-wheel-drive vehicle and at least one of the following is satisfied:
in addition to the measured variables at the driven wheels, motion variables of the non-driven wheels, which represent an angular motion of the non-driven wheels, are also combined with each other;
at least two different operation results are considered in the monitoring; and
the monitoring is performed as a function of the detection of at least one of an axle differential lock and an interaxle differential lock, with respect to a drive-torque distribution to the wheels.

20. A method for monitoring a tire state at driven wheels of a motor vehicle, the method comprising:
measuring angular motions of the driven wheels;
generating variables which are a function of the measured angular motions;
combining the generated variables with each other;
monitoring the tire state as a function of an operation result, wherein drive torque acting on the driven wheels is considered in the monitoring.

21. The method of claim 20, wherein a signal representing the tire state is generated as a function of the operation result, and as a function of the drive torque acting on the driven wheels; and the tire state is indicated to the driver based on the signal.

22. The method of claim 20, wherein at least two operation results are determined at at least two different drive torques, and a change in the operation results with respect to the drive torques is considered in at least one of the monitoring and the generating of the signal.

23. The method of claim 20, wherein the drive torque acting on the driven wheels is only considered in the monitoring in the presence of low drive torques below a threshold value

24. The method of claim 20, wherein the drive torque acting on the driven wheels is only considered in the monitoring in the presence of low drive torques less than a threshold value, and in the presence of higher drive torques greater than or equal to a threshold value, the monitoring is performed independently of the drive torque acting on the driven wheels.

25. The method of claim 20, wherein the monitoring is provided on an all-wheel-drive vehicle, and wherein at least one of the following is satisfied:
in addition to the measured variables at the driven wheels, motion variables of the non-driven wheels representing angular motion of the non-driven wheels are combined with each other,
at least two different operation results are considered in the monitoring, and
the monitoring is performed as a function of the detection of at least one of an axle differential lock and an interaxle differential lock with respect to a drive-torque distribution to the wheels.
